(19) United States
(12) Patent Application Publication
(10) Pub. No.: US 2016/0098702 A1
(43) Pub. Date: Apr. 7, 2016

(54) FRAUD PREVENTION USING PRE-PURCHASE MOBILE APPLICATION CHECK-IN

(71) Applicant: Edward J. Marshall, Bastrop, TX (US)

(72) Inventor: Edward J. Marshall, Bastrop, TX (US)

(21) Appl. No.: 14/505,759

(22) Filed: Oct. 3, 2014

(51) Int. Cl. G06Q 20/32; G06Q 20/40; G06Q 20/38

(52) U.S. Cl. CPC G06Q 20/3224; G06Q 20/382; G06Q 20/40

(57) ABSTRACT

The current location of a consumer can be determined and compared to the location of a merchant requesting approval of a credit card or debit card transaction. If the consumer is not at same location as the merchant, the payment can be declined. If the consumer is at the same location, the payment can be approved or declined according to normal rules. The current location of the consumer can be determined by having the consumer check in upon arrival at a store or shopping center by using an application running on the user's phone, tablet, or other mobile device. The location of the merchant can be determined based on information associated with the payment request. If the two locations match, the payment request is likely to come from the consumer.

### BACKGROUND OF THE INVENTION

1. Technical Field of the Invention

This invention relates generally to preventing fraudulent credit and debit card purchases, and more particularly to checking in at a merchant's location to pre-validate purchases made at that location.

2. Description of Related Art

Information collected by merchants during credit and debit card transactions is not as secure as some once believed it to be. But the safeguards put in place to protect that information are not always successful in preventing unauthorized persons from accessing the information. In some cases, hackers have been able to infiltrate merchant's computer systems to obtain payment transaction information such as credit card numbers, passwords, and personal identification numbers (PINS). The information is then often sold, or used to create counterfeit cards that are used to make fraudulent purchases that cost banks, consumers, and merchants huge sums of money. These breaches of security illustrate the shortcomings of currently available payment and fraud prevention systems.

### BRIEF DESCRIPTION OF THE SEVERAL VIEWS OF THE DRAWING(S)

FIG. 1 is a block diagram of a system used for preventing fraudulent use of payment instruments such as credit and debit cards, according to various embodiments of the present disclosure;

FIG. 2 is a block diagram illustrating a system that requires pre-purchase check-in prior to approving payment requests, according to various embodiments of the present disclosure;

FIG. 3 is a block diagram illustrating a payment processing system connected to a point of sale (POS) system via a communications network, according to various embodiments of the present disclosure;

FIG. 4 is a flow chart illustrating a method of preventing fraudulent credit card and debit card transactions according to various embodiments of the present disclosure; and

FIG. 5 illustrates elements of a computing device that can be used to implement various embodiments of the present disclosure.

### DETAILED DESCRIPTION

If the information needed to use a payment card is never presented to a merchant, that information cannot be stolen from a merchant. However, in the United States, the merchant needs to have the credit card number, expiration date, and other information stored in the magnetic strip to process the transaction. Once the merchant access that information, it is vulnerable to theft. In various European and Asian countries, smart chips are used in some credit cards so that information is always encrypted and not as easy to steal as information from magnetic strip-type cards used in the United States. However, even that information could be obtained.

At least one embodiment of the present disclosure uses a pre-purchase check-in procedure via a separate communication path to prevent fraudulently obtained payment card or account information from being used to make a purchase, even if the thief is in possession of all of the information conventionally needed to make a purchase. For example, if a merchant's records have been compromised, and a consumer's credit or debit card number, billing address, PIN number, and security verification code have been obtained by a thief, the thief will still not be able to make a purchase using the credit card unless the thief has also obtained the user's password or other login information to a pre-purchase check-in application. The pre-purchase check-in application need not be a stand-alone application, but can instead be a function or feature of a bank's website mobile application, or a feature of a check-in or pre-verification service.

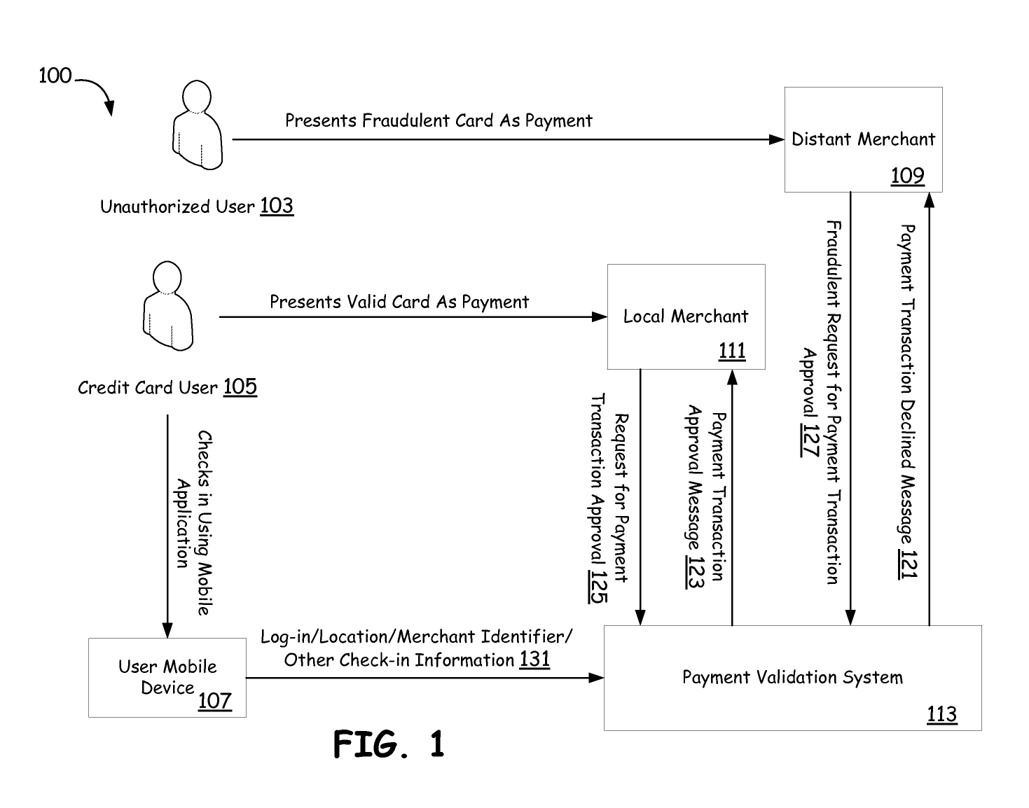

Referring to FIG. 1, a system 100 for preventing the fraudulent use of payment instruments will be discussed according to various embodiments of the present disclosure. System 100 includes user mobile device 107, which can be a mobile phone, a navigation/mapping device, a tablet, computer, fob, or other device capable of communicating with payment validation system 113, and which can be used by credit card user 105 to provide location information or perform pre-purchase validation or check-in; payment validation system 113, which approves or rejects payment requests based, at least in part, on pre-payment check-in information from user mobile device 107; local merchant 111 and distant merchant 109, which attempt to process payments using credit card, debit card, or other payment instruments presented by users 103 and 105.

In at least one embodiment, payment validation system 113 will allow approval of credit card, debit card, or other payment requests, subject to other approval safeguards, only if credit card user 105 has checked-in prior to a Request for Payment Transaction approval 125 being received at payment validation system 113. If unauthorized user 103 attempts to make a purchase at distant merchant 109, payment validation system 113 will respond to the Fraudulent Request for Payment Transaction Approval 127 with Payment Transaction Declined Message 122, because unauthorized user 103 has not provided payment validation system 113 with the necessary check-in information.

Credit card user 105 can check-in with payment validation system 113 by logging in to an application on a mobile device, where the application is configured to communicate check-in information 131 to payment validation system 113. The check-in information can include user name and password information, information from a certificate stored on mobile device 107, merchant identifier information, location information, or other similar information that can be used to verify the identity and/or location of credit card user 105.

The location information can include global positioning system (GPS) coordinates, a location derived from GPS coordinates, a location derived from radio tower connections and signal strengths, a user-entered location, a location determined based on network address, a location determined based on a merchant's address, or some combination thereof.

The merchant identifier information can be determined based on a store number obtained from user input selecting a merchant location displayed on a map, from a typed name of a merchant, from a list of merchants located at a mall or shopping center, from a merchant address or name entered directly by a user, or the like. In some embodiments, the merchant identifier can be obtained from a currently open browser window, a recent browsing history of the user, or from a cookie or other file stored on the user's local device. For example, if the user is browsing for shoe stores at a local shoe store that has a website, e.g. “Joe'sShoeStore.net,” the user can open a banking or credit issuer website that presents an option to “select a store recently browsed.” The application can then inspect the local device for cookies, and present the user a list of recently browsed stores to choose from. When the user selects that store, the information regarding the stores name and address can be obtained by the application running on mobile device 107, or information sufficient to obtain a merchant identifier and/or address can be sent to payment validation system 113.

Merchant identification information can, in some embodiments, be obtained by payment validation system 113 from merchant communications in addition to or in place of obtaining that information from user check-in information 131. The merchant identifier can be used to identify a location of the merchant, which can then be compared against the location of the user to determine whether payment approval will be potentially allowed. In some embodiments, the merchant identifier obtained from check-in information 131 can be compared to a merchant identifier obtained from the merchant during payment processing communications in addition to, or in place of, comparing locations. Comparing merchant identifiers can allow a shopper making purchases over the Internet to verify that the person requesting payment is, in fact, affiliated with the intended merchant.

In various embodiments, if check-in information 131 includes sufficient information to identifies the location of credit card user 105, and if the check-in information includes a merchant identifier having a location that matches the location of credit card user 105, payment validation system 113 can set a temporary flag on a payment account associated with credit card user 105, where the temporary flag indicates that purchase requests from the identified merchant at the matching location will be allowed to be processed for approval. Note that this flag need not automatically indicate approval of the purchase—normal approval procedures that verify availability of sufficient funds, proper PIN entry, proper expiration date, name, address, and zip code could still be followed as usual. In fact, in many instances, for example where the user goes to Joe's Shoe Store and determines that the quality is insufficient, there may not even be a request for payment received from Joe's Shoe Store.

In other embodiments, the check-in information 131 need not include a merchant identifier or merchant location, but may include authentication information and/or user location information. In some such embodiments, when credit card user 105 presents a valid card for payment to local merchant 111, local merchant 111 can send a Request for Payment Transaction Approval 125. Upon receipt of that request, payment validation system 113 can determine the location of the merchant, and determine whether or not the location of the merchant matches the location of credit card user 105. If the location of the merchant matches the location of credit card user 105, and if the payment request otherwise satisfies security and approval requirements, Payment Transaction Approval Message 123 can be sent to local merchant 111. If, Distant Merchant 109 sends Fraudulent Request for Payment Transaction Approval 127 to payment validation system 113, payment validation system 113 can check to see whether the location of distant merchant 109 matches the location of credit card user 105. If the locations do not match, payment validation system prevents payment authorization, even if the transaction meets other security checks, and sends a Payment Transaction Declined Message 121 to Distant Merchant 109.

As used herein, a location of a merchant can be said to match the location of credit card user 105 if the physical distance is less than a given threshold. This threshold can be based on user preferences, or set automatically by the system in some cases. For example, if a user checks-in at a Discounts 4 All store, at address A, but the payment request comes from the Discounts 4 All store fourteen blocks away from the user at location B, the payment request could be denied if the location threshold were set to “exact,” but could be approved if the location threshold were set to “City.” Examples of location thresholds include: within a radius of X from user's current location; or within a shopping center; within a political division, such as a county, city, state, subdivision.

Various implementations can use different location threshold granularity in combination with store identifiers. Examples of different location threshold granularities can be: “Merchant X—exact location”; “Any Merchant—exact location”; “Merchant X—any location within 1 mile radius”; or “Any Merchant—any location within a 3 mile radius”.

In addition a time threshold can be used as a proxy for either the user's location or a merchant's location, or as an additional limitation. For example, “Any Merchant—Any location—within the next hour,” “Any Merchant X—within a 30 minute estimated travel time from user's last check-in position,” or “Merchant X store number 4 within 3 hours of most recent check-in.”

In at least one embodiment, user mobile device 107 can be registered with payment validation system 113, and can continually, on demand, on request, or periodically provide location information to payment validation system 113. In such a case, credit card user 105 need not take any additional affirmative action to check-in at a particular location, because the check-in is performed on a substantially continuous basis. In yet other embodiments, credit card user 105 can provide payment validation system 113 with information about social media accounts, and payment validation system 113 can use status and location information from social media accounts to determine the current location of the user.

As used herein, a user's “current location” refers to the whereabouts of a user, and in at least some embodiments is not limited to the instantaneous current location of the user. Instead, a user's location can be considered to be his current location if the time that has elapsed since last receiving a location update is less than a threshold amount. For example, if the threshold amount is 5 minutes, the most recent location can be considered a current location if the user's location was updated within the last 5 minutes, within the last 30 minutes, within the last hour, or within another suitable time period threshold.

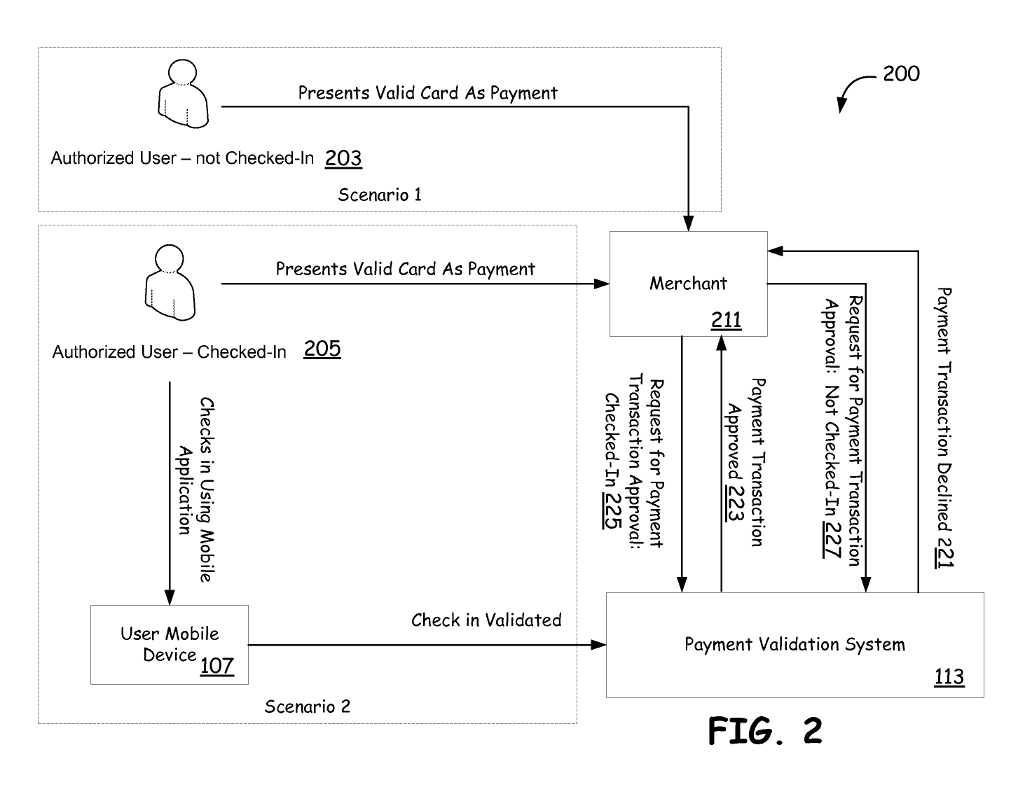

Referring next to FIG. 2, a system 200 requiring per-purchase check-in prior to approving payment requests even from an authorized cardholder is illustrated and discussed according to various embodiments of the present disclosure. More specifically, FIG. 2 depicts two possible scenarios: scenario 1 involving an attempted purchase by an authorized user 203, who is not checked in or who has checked in at a location that does not match merchant 211; and scenario 2 involving an attempted purchase by an authorized user 205, who has properly checked in and whose current location matches the location of merchant 211.

As shown in Scenario 1, an authorized user 203, who is not checked in, presents an otherwise apparently valid payment card to merchant 211. Merchant 211 sends a Request for Payment Transaction Approval 227 to payment validation system 113, which responds with a Payment Transaction Declined message 221, because authorized card user 203 has not checked in, or because the location of authorized user does not match the location of merchant 211.

In scenario 2, authorized user 205 checks-in with payment validation system 113 and provides his current location using a mobile application running on user mobile device 107. When user 205 presents his valid card for payment to merchant 211, merchant 211 sends a request for payment transaction approval 225 to payment validation system 113. Payment validation system 113 checks to make sure that the check-in of user 205 was made with valid credentials, and ensures that the location of user 205 obtained during the check-in matches the location of merchant 211. If the locations match, payment validation system 113 sends a payment transaction approved message 223 to merchant 211.

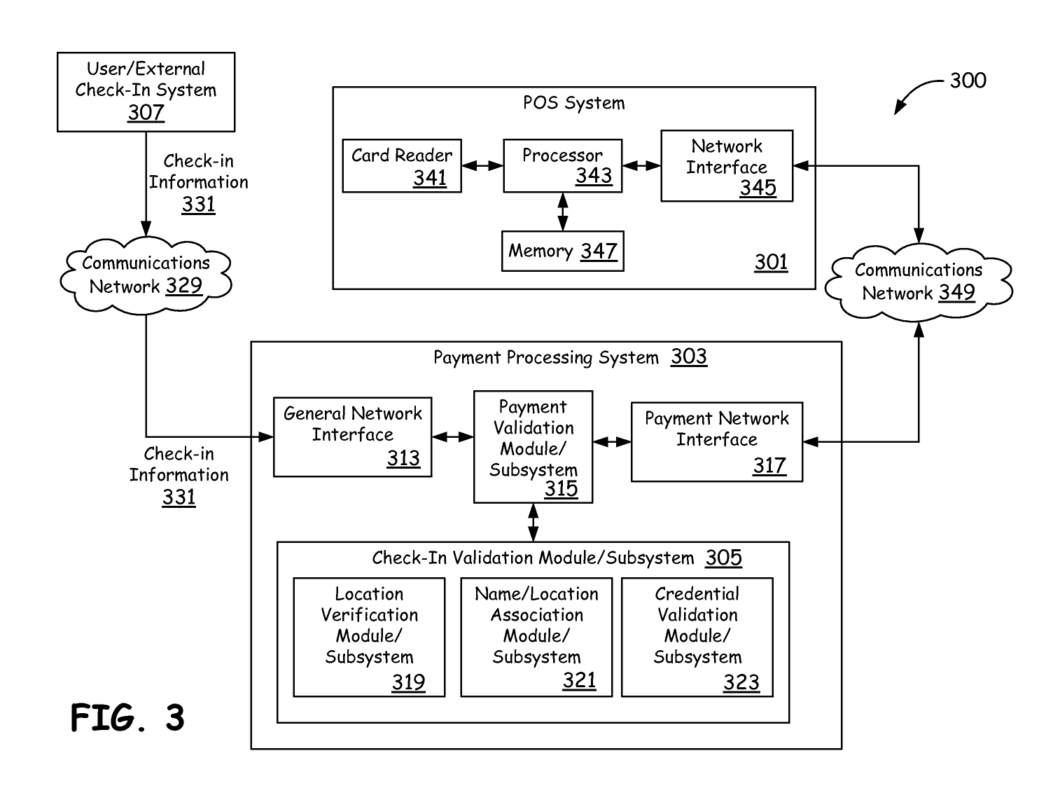

Referring next to FIG. 3, a block diagram of a system 300 including a payment processing system 303 and a point of sale (POS) system 301 will be discussed according to various embodiments of the present disclosure. POS system 301 can be a currently available POS system configured to communicate with payment processing system 303 via network 349. POS system 301 can include a card reader 341 configured to read magnetic stripe, “smart chip”, or other similar types of payment cards having information stored thereon; processor 343 and associated memory 347 configured to execute various well known POS functionality, and to transfer card information obtained from card reader 341 to payment processing system 303 through network interface 345 preferably, but not necessarily, in an encrypted format. Depending on the credit card approval process normally used, various levels and types of information can be sent to payment processing system 303 as part of a request for payment approval.

Payment processing system 303 includes general network interface 313, which can be used to obtain check-in information from a user device or external check-in system 307 via communications network 329. Payment processing system 303 also includes payment validation module/subsystem 315, which can be used in conjunction with check-in validation module/subsystem 305 to determine whether to approve payment authorization requests from POS system 301. Approval or rejection messages generated by payment validation module/subsystem 315 can be sent to POS system 301 via payment network interface 317 and communications network 349. In some embodiments, communications network can include a public wide area network, while other embodiments can employ a dedicated private network or direct physical connection. Where communications network 349 uses the Internet or public network infrastructure, various encryption, encoding, and tunneling techniques can be used to protect the privacy of transferred information.

Check-in Validation Module/Subsystem 305 includes location verification module/subsystem 319. name/location association module subsystem 3211, and credential validation module/subsystem 323. When a payment authorization request is received from POS system 301, payment validation module/subsystem 315 can be used to perform automated payment approval functions, such as determining whether a remaining amount of credit is sufficient to cover the requested payment authorization, verifying the credit card number, expiration date, PIN number, and the like. In some embodiments, payment validation module/subsystem 315 also checks to determine whether or not a lack of a valid check-in prevents payment approval if the normal, automated approval process indicates that the payment request would otherwise be approved. This check can be done, in some embodiments, by checking for a “check-in” or “location match” flag set by check-in validation module/subsystem 305.

Check-in validation module/subsystem 305 can set a check-in, or location match flag, or provide some other suitable message or indication to payment validation module/subsystem 315. In at least one embodiment, when check-in information 331 is received by payment processing system 303, location verification module subsystem 319 determines the current location of the user and stores that information. When POS system 301 sends a request for payment, information from the request can be sent to name/location association module/subsystem 321 to determine the location of the POS system 301. In some embodiments, the request from POS system 301 includes information, for example a store identifier, network address, or other information that allows the payment request to be associated with an actual physical location of the POS system. For example, a billing system used by payment processing system 303, or the billing system of a credit card processor, bank, or other institution involved in the payment process, can be queried to obtain the address in some embodiments

The check-in validation module/subsystem 305 can compare the location of the merchant or POS system obtained by name/location association module/subsystem 321 with the location of the user determined by location verification module/subsystem 319, to determine if the two location match.

Credential validation module/subsystem can be used to determine whether the login credentials of the user reporting his location via external check-in system 307 are valid, or otherwise make a determination that the user location information can be trusted. If the user location information can be trusted, and the location of the user and the POS match, check-in validation module/subsystem 305 can notify payment validation module/subsystem 315 that payment approval can be made, subject to satisfaction of other automated payment approval processes.

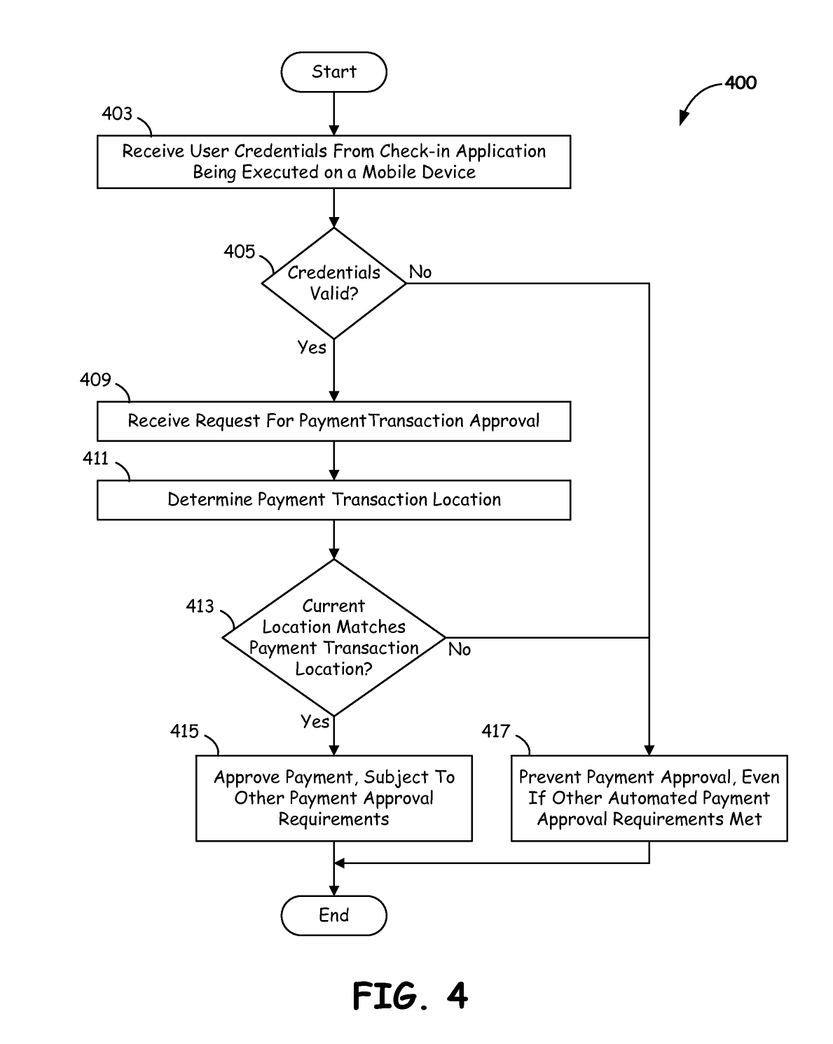

Referring next to FIG. 4, a method 400 will be discussed according to various embodiments of the present disclosure. As illustrated at block 403, user credentials are received from a check-in application being executed on a mobile device.

As illustrated by block 405, a check of the user's log-in credentials can be made to ensure that it is, in fact, the user who is attempting to provide his location or other check-in information. If the credentials do not match, method 400 proceeds to block 417, and sets a flag or other indicator to prevent payment approval, even if other automated payment approval requirements are met. In some embodiments, the check-in validation illustrated at block 405 can be performed by a banking website or third party service, so that only verified information is sent to a payment processing service. In other embodiments, the payment processing provider can perform some or all of the credential validation.

In at least one embodiment, safeguards can be enacted to temporarily disable or bypass the features described herein, so that a user who wants to make a purchase, but who does not have a mobile device that allows check-in, can still access his accounts. Such safeguards can include the ability to call payment verification system 113 or a credit card provider and go through an elevated level of authentication. Another way is to obtain user preferences at a website or via a phone call that activate or deactivate one or more features described herein, either permanently or for a limited time period. In some embodiments, the check-in verification described herein can be presented as a higher-security option by a credit card provider. Incentives can also be offered so that users who agree to check-in location verification will receive discounted interest rates as a reward for helping to fight fraudulent transactions.

In addition to total deactivation, a user can, in some embodiments, opt for non-check-in transactions to be limited to less than a preset dollar amount, or a credit card provider can set different transaction approval limits based on whether or not a employs user/merchant location comparison, or pre-purchase check-in.

As illustrated at block 409, a request for payment transaction approval is received. From information associated with or included in the request, the payment transaction location can be determined, as illustrated at block 411. As shown at block 413, the payment transaction location can be compared to the current location of the user obtained from the user's check-in information.

If the payment transaction matches the user's current location, method 400 proceeds to block 415, which illustrates that the payment transaction is allowed to be approved. Note that allowing approval does not exempt the payment request from all other automated safeguards and approval requirements. Instead, the location match simply provides an additional layer of assurance that the request for payment is actually being made by an authorized consumer.

If the payment transaction and the user's current location do not match, method 400 proceeds to block 417, and the transaction is disapproved. In at least one embodiment, preventing transaction approval at non-matching locations will help prevent a fraudulent card from being used.

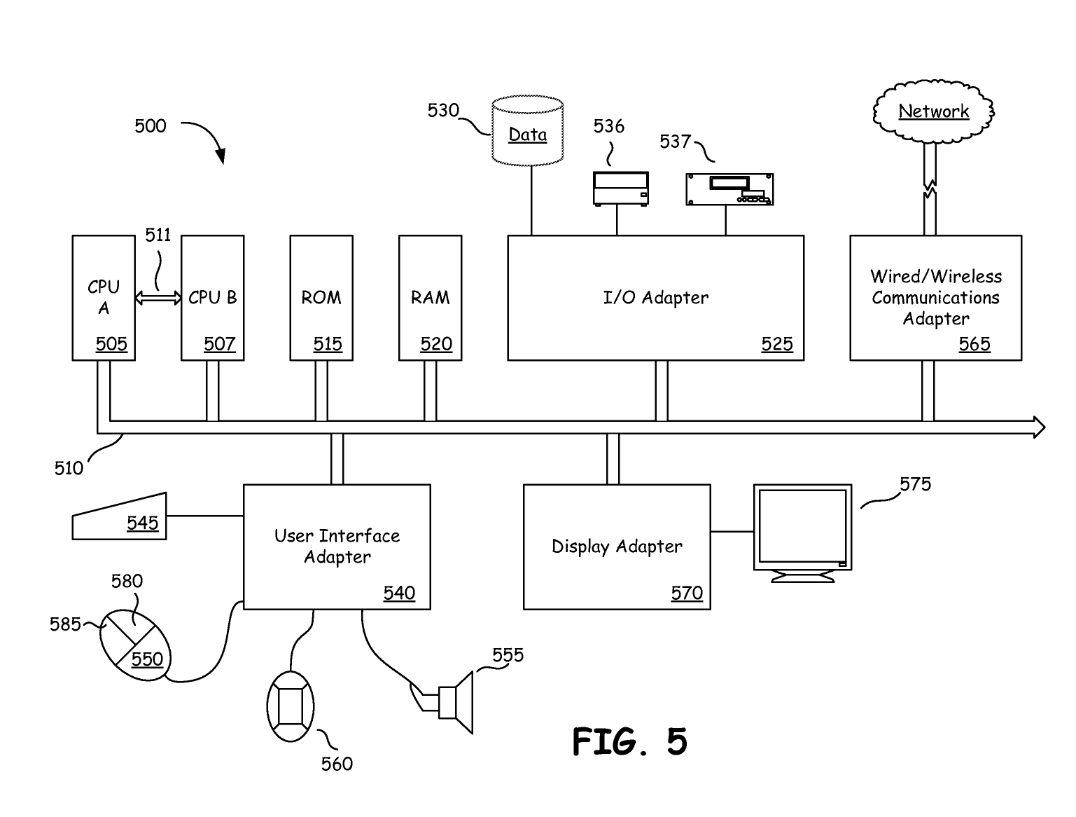

Referring now to FIG. 5, a high-level block diagram of a processing system is illustrated and discussed. Processing system 500 includes one or more central processing units, such as CPU A 505 and CPU B 507, which may be conventional microprocessors interconnected with various other units via at least one system bus 510. CPU A 505 and CPU B 507 may be separate cores of an individual, multi-core processor, or individual processors connected via a specialized bus 511. In some embodiments, CPU A 505 or CPU B 507 may be a specialized processor, such as a graphics processor, other co-processor, or the like.

Processing system 500 includes random access memory (RAM) 520; read-only memory (ROM) 515, wherein the ROM 515 could also be erasable programmable read-only memory (EPROM) or electrically erasable programmable read-only memory (EEPROM); and input/output (I/O) adapter 525, for connecting peripheral devices such as disk units 530, optical drive 536, or tape drive 537 to system bus 510; a user interface adapter 540 for connecting keyboard 545, mouse 550, speaker 555, microphone 560, or other user interface devices to system bus 510; communications adapter 565 for connecting processing system 500 to an information network such as the Internet or any of various local area networks, wide area networks, telephone networks, or the like; and display adapter 570 for connecting system bus 510 to a display device such as a display screen 575. Mouse 550 has a series of buttons 580, 585 and may be used to control a cursor shown on display screen 575.

It will be understood that processing system 500 may include other suitable data processing systems without departing from the scope of the present disclosure. For example, processing system 500 may include bulk storage and cache memories, which provide temporary storage of at least some program code in order to reduce the number of times code must be retrieved from bulk storage during execution.

Various disclosed embodiments can be implemented in hardware, software, or a combination containing both hardware and software elements. Some embodiments may be realized as a non-transitory computer program product, including computer-usable or computer-readable media tangibly embodying program code for execution in a computer, a processor, or other suitable instruction execution system. For the purposes of this description, a computer-usable or computer readable medium can be any non-transitory apparatus that can contain, store, communicate, or transport the program for use by or in connection with an instruction execution system, apparatus, or device. By way of example, and not limitation, computer readable media may comprise any of various types of computer storage media, including volatile and non-volatile, removable and non-removable media implemented in any suitable method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The embodiments have been described herein in an amount of detail sufficient to allow one of ordinary skill in the art to make and use the claimed invention without undue experimentation. Variations and modifications of the embodiments disclosed can be made based on the description provided, without departing from the scope of the invention as set forth in the following claims.

What is claimed is:

1. A method of preventing fraudulent payment transactions associated with a payment account associated with a user, the method comprising:
receiving a current location of the user from a mobile device;
receiving a request for approval of a payment transaction associated with the payment account associated with the user;
determining whether a location associated with the payment transaction matches the current location of the user;
in response to the determining indicating a match, allowing approval of the payment transaction, subject to other automated payment approval requirements associated with the payment account; and
in response to the determining indicating no-match, preventing approval of the payment transaction pending second level authentication, even if the other automated payment approval requirements associated with the payment account are satisfied.

2. The method of claim 1, wherein the receiving the current location of the user from a mobile device comprises:
receiving user log-in credentials via an application being executed by the mobile device.

3. The method of claim 1, wherein the receiving the current location of the user from a mobile device comprises:
receiving information indicating a merchant name at which the user intends to make a purchase.

4. The method of claim 1, wherein the receiving the current location of the user from a mobile device comprises:
receiving global positioning system (GPS) information indicating a position of the user.

5. The method of claim 1, wherein the current location has been updated within a threshold period of time prior to the receiving the request for approval of the payment transaction.

6. The method of claim 1, wherein the location associated with the payment transaction matches the current location of the user if the location associated with the payment transaction is within a perimeter associated with the current location.

7. The method of claim 6, wherein the perimeter associated with the current location includes at least one of a radial distance from GPS coordinates of the user, a shopping center boundary, a political boundary, or a maximum estimated travel time from a last-known current location of the user.

8. A device configured to validate payment requests associated with a payment account of a user, the device comprising:
a network interface coupled to a wide area network, the network interface configured to:
receive a current location of the user;
receiving an indication that approval has been requested for a payment transaction associated with the payment of the user, wherein the indication that approval has been requested includes a location associated with the payment transaction;
a processor and associated memory configured to:
determine whether the location associated with the payment transaction matches the current location of the user;
in response to a match, allowing approval of the payment transaction, subject to other automated payment approval requirements associated with the payment account; and
in response to the determining indicating no-match, preventing approval of the payment transaction pending second level authentication, even if the other automated payment approval requirements associated with the payment account are satisfied.

9. The device of claim 8, wherein the network interface is further configured to receive an indication that approved user log-in credentials have been provided from a mobile device associated with the user.

10. The device of claim 8, wherein the current location of the user includes a merchant identifier.

11. The device of claim 8, wherein the current location of the user includes global positioning system (GPS) information indicating a position of the user.

12. The device of claim 8, wherein the current location is considered current only if the current location has been updated within a threshold period of time prior to approval of the payment transaction being requested.

13. The device of claim 8, wherein the location associated with the payment transaction matches the current location of the user if the location associated with the payment transaction is within a perimeter associated with the current location of the user.

14. The device of claim 13, wherein the perimeter associated with the current location of the user includes at least one of a radial distance from GPS coordinates of the user, a shopping center boundary, a political boundary, or a maximum estimated travel time from a last-known current location of the user.

15. A payment validation system comprising:
a network interface configured to:
receive a current location of the user
receive an indication that approval has been requested for a payment transaction associated with the payment of the user, wherein the indication that approval has been requested includes a location associated with the payment transaction;
a processor and associated memory configured to:
make a first determination regarding whether the location associated with the payment transaction matches the current location of the user;
make a second determination regarding whether the current location of the user has been updated before a threshold period of time elapsed since the current location of the user was received;
in response to both the first determination indicating a match and the second determination indicating that the threshold period of time has not yet elapsed, allowing approval of the payment transaction, subject to other automated payment approval requirements associated with the payment account; and
in response to either the first determination indicating no-match or the second determination indicating that the threshold period of time has elapsed, preventing approval of the payment transaction pending second level authentication, even if the other automated payment approval requirements associated with the payment account are satisfied.

16. The payment validation system of claim 15, wherein the network interface is further configured to receive an indication that approved user log-in credentials have been provided from a mobile device associated with the user.

17. The payment validation system of claim 15, wherein the current location of the user includes a merchant identifier.

18. The payment validation system of claim 15, wherein the current location of the user includes global positioning system (GPS) information indicating a position of the user.

19. The payment validation system of claim 15, wherein the location associated with the payment transaction matches the current location of the user if the location associated with the payment transaction is within a perimeter associated with the current location of the user.

20. The payment validation system of claim 19, wherein the perimeter associated with the current location of the user includes a political boundary.
